(19) United States
(12) Patent Application Publication
(10) Pub. No.: US 2011/0158420 A1
(43) Pub. Date: Jun. 30, 2011

(54) STAND-ALONE EAR BUD FOR ACTIVE NOISE REDUCTION

(75) Inventor: Mark Hannah, Bad Fischau-Brunn (AT)

(73) Assignee: NXP B.V., Eindhoven (NL)

(21) Appl. No.: 12/647,373

(22) Filed: Dec. 24, 2009

(51) Int. Cl. G10K 11/16

(52) U.S. Cl. 381/71.6

(57) ABSTRACT

An ear bud and noise reduction system actively reduce noise in one ear while the user listens with the other ear to an audio sound wave produced by the speaker of an electronic device (e.g., a cell phone or a wireless headset attachable to a single ear). The ear bud includes a microphone, an active noise reduction unit, and an audio speaker. The active noise reduction unit produces a noise reduction signal based on ambient noise sensed by the microphone in the vicinity of a first ear while an electronic device produces a first audio sound wave in the vicinity of a second ear. The audio speaker produces a second audio sound wave in the vicinity of the first ear based on the noise reduction signal to reduce or substantially cancel the ambient noise. The first and second audio sound waves may be produced independently of each other.

### BACKGROUND

1. Technical Field

The present disclosure relates to an ear bud, and, in particular, to an ear bud that actively reduces ambient noise reaching a person's ear while the person listens to audio sound waves produced by a loudspeaker of an electronic device, such as a phone, with the other ear.

2. Background of Related Art

When making a phone call in a noisy environment (e.g., an airport), it is common for a person to cover one ear with one hand while holding the speaker of a phone to their other ear with the other hand. For example, as shown in FIG. 1, when a person uses a phone 120 in a noisy environment and finds it difficult to understand the audio sound waves produced by the loudspeaker of the phone 120, they often position a finger 111 of a “free” hand 110a to cover the ear canal of the ear 115 to block out the noise while he is holding the phone 120 with the other hand 110b. This reduces the ambient noise at the ear that is closest to the phone and allows the user to concentrate on and better understand the audio sound waves (e.g., the sound waves of a person's voice) produced by the speaker of the phone 120.

However, the problem with using a finger or any other passive noise reduction technique (e.g., an ear plug) is that it is difficult to effectively cancel out or reduce the ambient noise. In addition, the user needs one hand to hold the telephone to one ear and the other hand to cover or plug the other ear. As a result, the user has no free hand available to use for other activities, such as taking out a wallet, writing down notes, and opening a door.

### SUMMARY

The present disclosure, in one aspect, features a stand-alone ear bud that actively reduces or effectively cancels ambient noise at a person's first ear while the person holds the speaker of an electronic device proximate to the person's second ear. The ear bud thus replaces and improves upon a person's hand that is typically used to block the ear in noisy environments and allows the person to perform other tasks with that hand. The ear bud includes a microphone, an active noise reduction unit, and a speaker. The active noise reduction unit produces a noise reduction signal based on ambient noise sensed by the microphone in the vicinity of a first ear while an electronic device produces a first audio sound wave at a second ear. The speaker produces a second audio sound wave at the first ear based on the noise reduction signal.

In some embodiments, the microphone is positioned on the ear bud to sense ambient noise within an ear canal of the first ear when the ear bud covers the ear canal. In other embodiments, the microphone is positioned on the ear bud to sense the ambient noise outside of the ear canal when the ear bud covers the ear canal. In some embodiments, the noise reduction signal is a signal that cancels at least a portion of the ambient noise.

In some embodiments of the present disclosure, the electronic device is a phone. The phone may include a wired or wireless headset for a single ear. The ear bud may include at least one compliant lip that is configured to be inserted into the ear canal and/or the ear concha. In some embodiments, the active noise reduction unit includes a filter that modifies the noise reduction signal. The active noise reduction unit may consist of an inverter and an amplifier. In other embodiments, the active noise reduction unit is not coupled to the electronic device that produces the first audio sound wave at the second ear.

The present disclosure, in another aspect, features a noise reduction phone system. The system includes a phone and an ear bud with an active noise reduction unit. The phone includes circuitry that receives a communications signal and produces a first audio sound wave at a first ear of a person based on the communications signal. In addition to the active noise reduction unit, the ear bud includes a microphone and a speaker. The active noise reduction unit produces a noise reduction signal based on the ambient noise sensed by the microphone. The speaker produces a second audio sound wave based on the noise reduction signal at a second ear of the person.

In certain embodiments of the noise reduction phone system, the phone is not coupled to the ear bud. Also, the ear bud may not include circuitry that reproduces the audio signals. In some embodiments, the phone includes a wired or wireless headset attachable to a single ear. The phone may be a cell phone. Alternatively, the phone may be connected to a telephone network via a wired connection. The phone also may be a cordless phone which communicates via radio with a base unit, and that base unit communicates with the telephone network via a wired connection. In some embodiments, the noise reduction signal is a signal that cancels or at least reduces the ambient noise.

The present disclosure, in yet another aspect, features a method, implemented through use of analog or digital circuitry, of increasing the audibility of an audio sound wave produced by an electronic communications device in ambient noise. The method includes sensing ambient noise, producing a first audio sound wave that reduces the sensed ambient noise at a first ear of a person, and producing a second audio sound wave by an electronic communications device at a second ear of the person. According to this method, the producing of the first audio sound wave is independent of the producing of the second audio sound wave.

### BRIEF DESCRIPTION OF THE DRAWINGS

Various embodiments of the subject instrument are described herein with reference to the drawings wherein:

FIG. 1 is an illustration of a person speaking on a cell phone;

FIG. 2 is a diagram of an ear bud positioned in a human ear in accordance with embodiments of the present disclosure;

FIG. 3 is a functional block diagram of an ear bud in accordance with embodiments of the present disclosure;

FIG. 4 is a circuit block diagram of an active noise reduction unit in accordance with embodiments of the present disclosure;

FIG. 5 is a circuit block diagram of an active noise reduction system in accordance with embodiments of the present disclosure;

FIG. 6 is an illustration of a person using an active noise reduction system in accordance with embodiments of the present disclosure; and

FIG. 7 is a flow diagram of a process executed by the active noise reduction system of FIG. 5 in accordance with embodiments of the present disclosure.

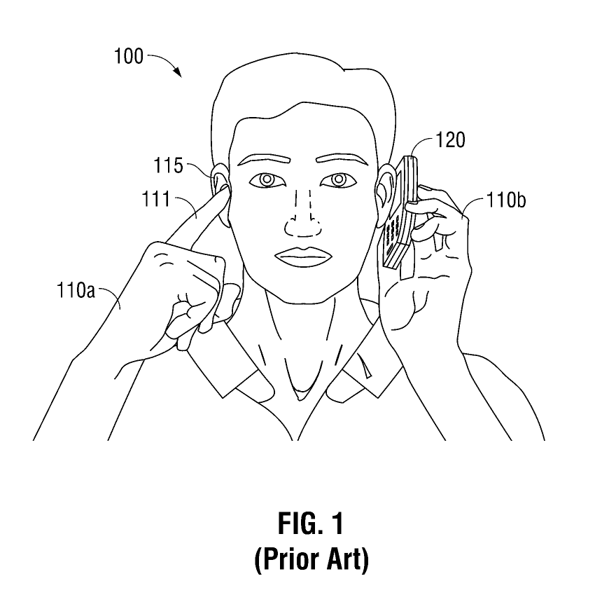

### DETAILED DESCRIPTION

Embodiments of the presently disclosed ear bud and system for reducing ambient noise at one ear while the user listens to the speaker of an electronic device with the other ear are now described in detail with reference to the drawings, in which like reference numerals designate identical or corresponding elements in each of the several views. It should be understood that the foregoing description is only illustrative of the present disclosure.

The “electronic finger” ear bud according to embodiments of the present disclosure is a small electronic device that includes a loudspeaker, a microphone, a power source, and noise reduction electronics. When a user receives a telephone call via a phone, the user places the ear bud in their free ear instead of their finger. The ear bud actively reduces ambient noise reaching the free ear and allows the user to have a phone conversation while still having at least one hand free. Thus, the ear bud effectively replaces the finger being held in the user's ear. The ear bud not only passively blocks unwanted noise (through a tightly sealed headphone part), but also actively reduces the ambient noise by producing appropriate “anti-noise.”

The electronic ear bud does not need to communicate with the phone (e.g., via a wired connection or via Bluetooth). This makes the electronic ear bud cheaper and simpler than existing, active noise reduction devices. Also, the ear bud may be smaller than existing devices, thereby increasing its portability and increasing its acceptance by consumers. In addition, the electronic ear bud uses less power than existing active noise reduction devices because the ear bud neither reproduces music, nor communicates with the electronic device (e.g., a cell phone). This reduces the size of the battery and thus the total size of the electronic ear bud. This also increases the battery life.

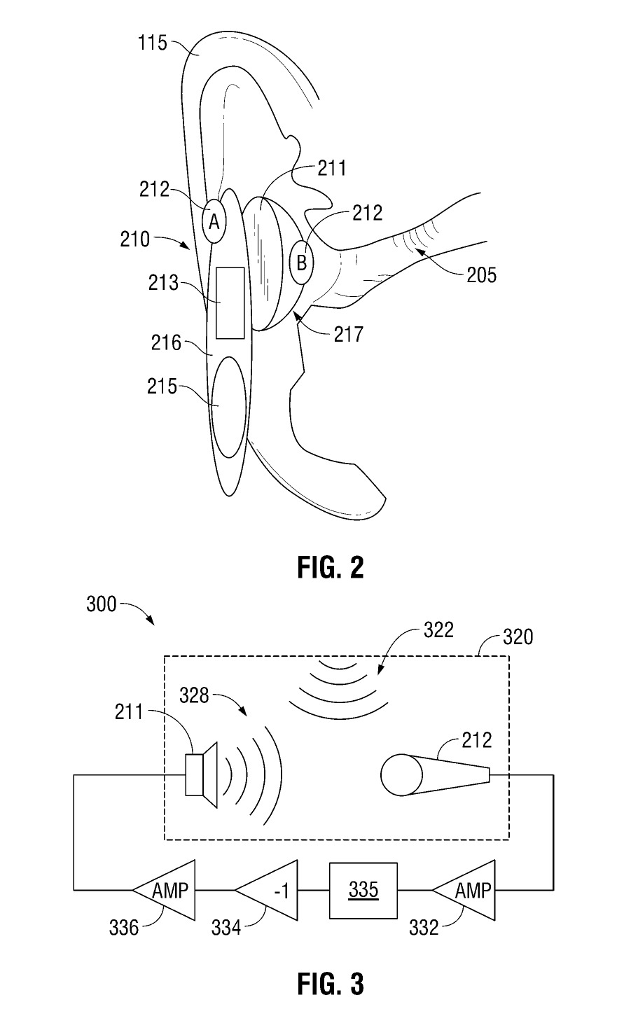

FIG. 2 is a diagram of an electronic ear bud 210 (also referred to as an ear pod) that is used to reduce ambient noise. The ear bud 210 includes a soft lip 217 that closes over the ear canal 205 (a tight fit over the ear canal will improve acoustic isolation, but preferably should still be comfortable for the wearer). The ear bud 210 may be constructed of foam, plastic, rubber or any other material (or combination of these materials) that can conformably close over the ear canal 205. The ear bud 210 can be configured as either an “in-ear canal” ear bud, where the rubber lips 217 are inserted into the ear canal 205, or an intra-concha ear bud, where a small bud is placed in the ear concha (i.e., the hollow of the ear that is external to the opening of the ear canal 205), but not inserted into the ear canal (as in some MP3 player headphones).

The ear bud 210 also includes a speaker 211 that faces towards the ear canal 205 and when suitably driven produces an “anti-noise” signal to reduce or cancel out undesired ambient noise. The ear bud 210 also includes a boom 216 that includes a power source 215 (the boom shape is disclosed for ease of handling, but other shapes could be used as well). In some embodiments, the power source 215 is a battery or a rechargeable battery. In other embodiments, the power source 215 is a solar power source. The ear bud also includes a microphone 212 that is positioned either outside of the ear canal 205 on the boom 216 (at position A) or inside of the ear canal 205 (at position B). In some embodiments, microphones 212 are positioned both inside and outside of the ear canal 205 (at positions A and B). The microphone(s) 212 are configured to detect ambient noise.

The ear bud 210 also includes electronics (e.g., discrete components or an integrated chip) 213 that implement active noise reduction or cancellation algorithms to actively produce “anti-noise,” which reduces or cancels ambient noise to give the user the impression that no ambient or environmental noise is present.

The ear bud 210 is placed in a “free” or “open” ear while the person makes a telephone call or otherwise uses an electronic device using the other ear in a noisy environment. In current active noise reduction devices, the active noise reduction circuitry is part of the music or telephony headsets or headphones and are typically stereo (an ear bud for each ear). Moreover, these devices include the ability to reproduce voice or music that is supplied by a host device, such as an MP3 player or mobile phone, all of which factors increase cost and complexity of the device. In contrast, the electronic ear bud 210 according to some embodiments of the present disclosure is not coupled or connected, either mechanically or electrically, to the electronic device (e.g., mobile phone) and the ear bud is not intended to reproduce the audio signals (e.g., voice or music audio signals) that are produced by the electronic device.

FIG. 3 is a functional block diagram of an ear bud 300 having active noise reduction circuitry in accordance with embodiments of the present disclosure. The speaker 211 and the microphone 212 are positioned in the vicinity of a human ear as represented by the dotted box 320. In some embodiments, the ear bud 300 includes multiple microphones and/or multiple speakers that are positioned on the ear bud 300 in the vicinity of the human ear 320 to improve the reduction or cancellation of ambient noise 322.

The microphone 212 senses the ambient noise 322 that is present in the vicinity of the human ear 320 and generates an ambient noise signal based on the ambient noise 322. In some embodiments, an amplifier 332 amplifies the ambient noise signal and a signal modification unit 335 modifies the ambient noise signal. The modification unit 335 may be a filter or other circuitry that modifies the ambient noise signal to produce a noise reduction signal with desired characteristics. In some embodiments, the modification unit 335 may allow certain sound waves to pass through to the ear without being cancelled or otherwise attenuated. For example, the modification unit 335 may allow the sound wave of an emergency siren (e.g., the siren of an emergency fire vehicle) to pass through to the ear.

The inverter 334 inverts the ambient noise signal and the amplifier 336 amplifies the resulting signal to a level appropriate for the loudspeaker 211 (any other suitable scheme for generating anti-noise sound waves also could be used). The speaker 211 then produces audio sound waves 328 based on the processed ambient noise signal. In some embodiments, the active noise reduction circuitry generates anti-noise sound waves 328 that are identical to the ambient noise sound waves 322 except that they are phase shifted by 180 degrees. Such an anti-noise sound wave would cancel the ambient noise sound waves 320 in the vicinity of the human ear 320. In other embodiments, the active noise reduction circuitry may generate an anti-noise sound wave that reduces the intensity of the ambient noise.

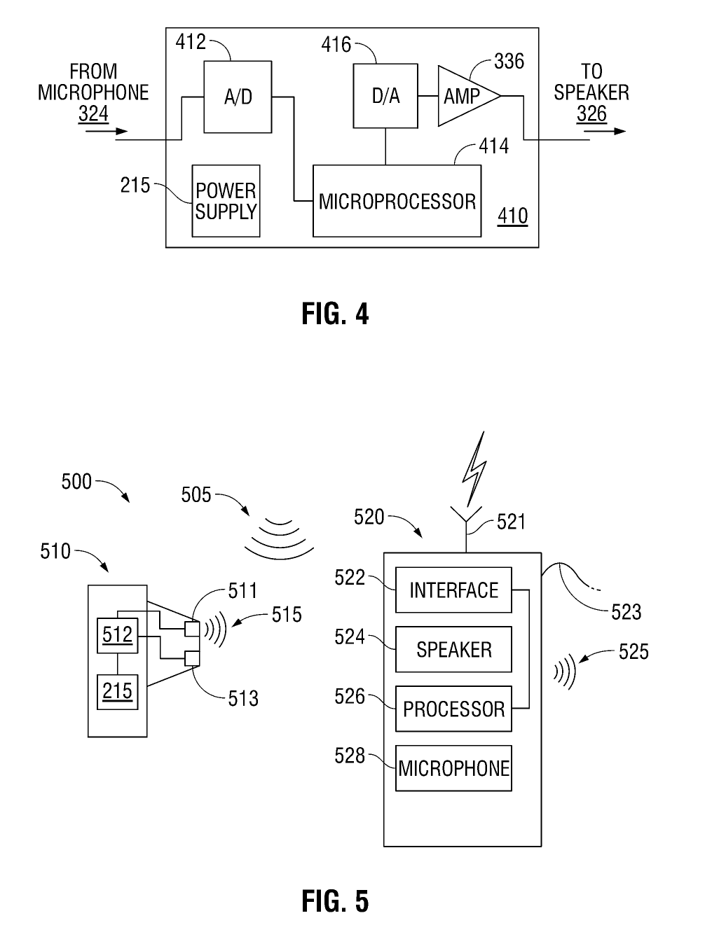

FIG. 4 is a circuit block diagram of an active noise reduction unit 410 in accordance with a digital embodiment of the present disclosure. In addition to the power supply 215 of FIG. 2 and the amplifier 336 of FIG. 3, the digital noise reduction unit 414 includes an analog-to-digital converter 412, a microprocessor 414, and a digital-to-analog converter 416. The analog-to-digital converter 412 converts the audio signal produced by the microphone 324 into a digitized audio signal and provides this signal to the microprocessor 414. The microprocessor 414 inverts the digitized audio signal to produce a digitized audio signal that is phase shifted 180 degrees compared to the digitized audio signal.

The microprocessor 414 may also perform other signal processing functions to modify the properties of the digitized audio signal or the inverted digitized audio signal. For example, the microprocessor 414 may alter the frequency characteristics of the inverted digitized audio signal to allow a user to hear certain audio sound frequencies in the ambient noise, such as a police siren or other alarm. The microprocessor 414 may also adjust the gain of the amplifier 336, for example, based on certain properties of the ambient noise sensed by the microphone 324.

The microprocessor 414 provides a processed digitized audio signal to the digital-to-analog converter 416, which converts the processed digitized audio signal into analog form. The resulting analog signal is then amplified by amplifier 336 and applied to the speaker 326. The advantage of the digital noise reduction unit 414 is that the microprocessor 414 can execute any number of signal processing algorithms that are downloaded to the memory of the microcontroller 414.

FIG. 5 is a circuit block diagram of a noise reduction system in accordance with embodiments of the present disclosure. The noise reduction system includes an electronic device 520 for a first ear and an ear bud 510 for a second ear. The electronic device 520 includes a communications interface 522 that sends and receives communications signals via a wireless antenna 521 and/or a wired connection 523 (e.g., a wired connection to a telephone network or to the Internet). The communications interface 522 is coupled to a processor 526. The processor 526 processes audio signals received from a microphone 528 and transmits the processed signals to the communications interface 522. The processor 526 also receives communication signals from the communications interface 522, processes the signals, and transmits audio signals to the speaker 522, which produces audio sound waves 525 corresponding to the audio signal.

When a person uses the electronic device 520, an audio speaker 511 of the ear bud 510 independently produces an anti-noise sound wave 515 that reduces or cancels ambient noise 505. The ear bud 510 includes a microphone 513 that senses ambient noise 505 and produces an ambient noise signal. An active noise reduction unit includes signal processing circuitry 512 that inverts the ambient noise signal and performs other signal processing functions to produce an anti-noise signal. The speaker then produces an anti-noise sound wave 515 based on the anti-noise signal, which reduces or effectively cancels the ambient noise 505.

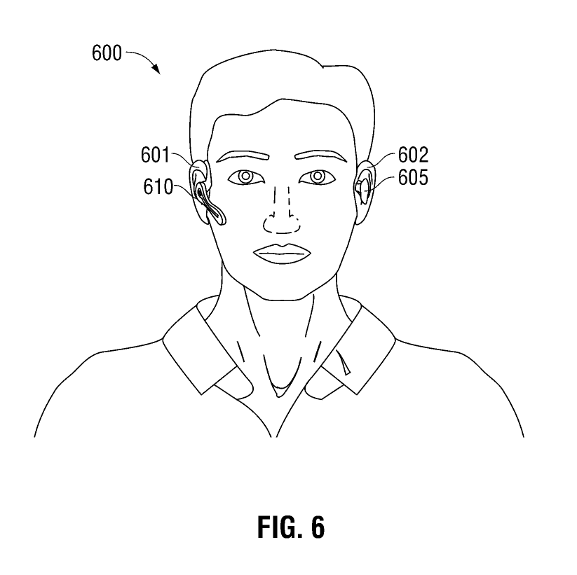

FIG. 6 is an illustration of a person using a noise reduction system in accordance with an embodiment of the present disclosure. As illustrated, the person 600 attaches a wireless earpiece 610 to one ear 601 and inserts an ear bud with noise reduction circuitry 605 into the other ear 602. The advantage of this active noise reduction system is that the person is left with two free hands to perform any task that requires the use of two hands, such as typing in a noisy airport or operating equipment that generates elevated levels of noise (e.g., a lawn mower).

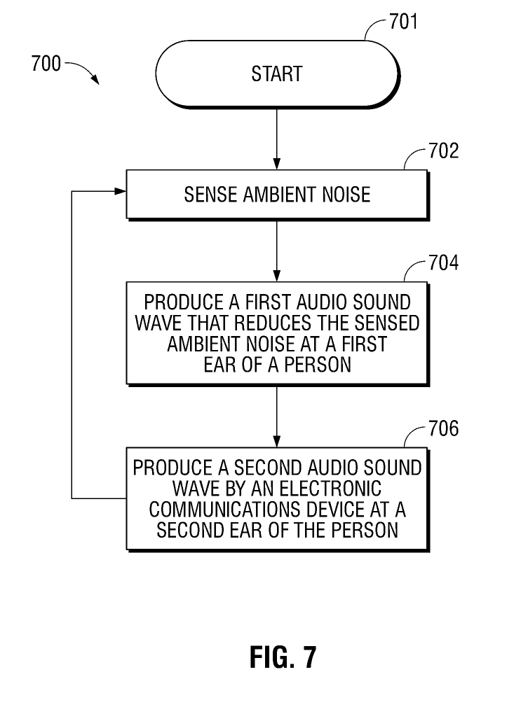

FIG. 7 is a flow diagram of a process 700 executed by the noise reduction system of FIG. 5. After the process is initiated 701, the microphone of the ear bud senses ambient noise 702. The active noise reduction unit 512 of the ear bud 210 then produces a first audio sound wave that reduces the sensed ambient or environmental noise at a first ear of a person 704. Lastly, a separate electronic communications device produces a second audio sound wave at a second ear of the person 706. Steps 702 through 706 are then repeated to increase or otherwise improve the audibility of audio sound waves produced by the speaker of an electronic device (e.g., a cell phone) for a single ear in a noisy environment.

It will be further appreciated that a pair of ear buds in accordance with this invention can be used by one person as an inexpensive alternative to a conventional set of noise-reducing headphones.

Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods and techniques that are insubstantially different from those described above and/or in the appended claims are also intended to be within the scope of the disclosure.

The drawings described are only schematic and are non-limiting. In the drawings, for illustrative purposes, the size of some of the elements may be exaggerated and not drawn to a particular scale. Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. This expression signifies that, with respect to the present invention, the only relevant components of the device are A and B.

Furthermore, the terms “first”, “second”, “third” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the embodiments of the invention described herein are capable of operation in other sequences and/or arrangements than are described or illustrated herein.

What is claimed is:

1. An ear bud comprising:
a microphone;
an active noise reduction unit configured to produce a noise reduction signal based on ambient noise sensed by the microphone in the vicinity of a first ear while an electronic device produces a first audio sound wave for a second ear; and
a speaker that produces a second audio sound wave at the first ear based on the noise reduction signal.

2. The ear bud of claim 1, wherein the microphone is positioned on the ear bud to sense ambient noise within an ear canal of the first ear when the ear bud covers the ear canal.

3. The ear bud of claim 1, wherein the microphone is positioned on the ear bud to sense the ambient noise outside of the ear canal when the ear bud covers the ear canal.

4. The ear bud of claim 1, wherein the noise reduction signal is a signal effective to cancel at least a portion of the ambient noise.

5. The ear bud of claim 1, wherein the electronic device is a phone.

6. The ear bud of claim 5, wherein the phone includes a wired or wireless headset for a single ear.

7. The ear bud of claim 1, wherein the ear bud includes at least one compliant lip that is configured to be inserted into the ear canal.

8. The ear bud of claim 1, wherein the ear bud includes at least one compliant lip that is configured to be inserted into the ear concha.

9. The ear bud of claim 1, wherein the active noise reduction unit includes a filter that modifies the noise reduction signal.

10. The ear bud of claim 1, wherein the active noise reduction unit consists of an inverter and an amplifier.

11. The ear bud of claim 1, wherein the active noise reduction unit is not coupled to the electronic device.

12. A noise reduction phone system, comprising:
a phone comprising circuitry that receives a communications signal and produces a first audio sound wave at a first ear of a person based on the communications signal; and
an ear bud comprising:
a microphone;
an active noise reduction unit that produces a noise reduction signal based on an ambient noise sensed by the microphone; and
a speaker that produces a second audio sound wave based on the noise reduction signal at a second ear of the person.

13. The noise reduction phone system of claim 12, wherein the phone is not coupled to the ear bud.

14. The noise reduction phone system of claim 12, wherein the ear bud does not include circuitry that reproduces the audio signals.

15. The noise reduction phone system of claim 12, wherein the phone includes a wired or wireless headset attachable to a single ear.

16. The noise reduction phone system of claim 12, wherein the phone is a cell phone.

17. The noise reduction phone system of claim 12, wherein the phone is connected to a telephone network via a wired connection.

18. The noise reduction phone system of claim 12, wherein the noise reduction signal is a signal that substantially cancels the ambient noise.

19. A method of increasing the audibility of an audio sound wave produced by an electronic communications device in ambient noise, comprising:
sensing ambient noise;
producing a first audio sound wave that reduces the sensed ambient noise at a first ear of a person; and
producing a second audio sound wave by an electronic communications device at a second ear of the person,
wherein the producing of the first audio sound wave is independent of the producing of the second audio sound wave.
